(19) United States
(12) Patent Application Publication
(10) Pub. No.: US 2026/0096547 A1
(43) Pub. Date: Apr. 9, 2026

(54) SYSTEMS, METHODS AND NON-TRANSITORY COMPUTER-READABLE MEDIA FOR CLOSED LOOP SPRAYER CONTROL

(71) Applicant: Deere & Company, Moline, IL (US)

(72) Inventors: Lance R. SHERLOCK, Asbury, IA (US); Kelsey L. CARLSON, Hudson, IA (US)

(73) Assignee: Deere & Company, Moline, IL (US)

(21) Appl. No.: 18/905,633

(22) Filed: Oct. 3, 2024

(51) Int. Cl. A01M 7/00; A01C 23/00; A01C 23/04; B05B 3/02; B05B 12/16; B05B 13/00

(52) U.S. Cl. CPC A01M 7/0089; A01C 23/007; A01C 23/047; A01M 7/0042; B05B 3/0204; B05B 12/16; B05B 13/005

(57) ABSTRACT

Systems, methods, and non-transitory computer-readable media for controlling a crop sprayer. A system includes one or more perception devices configured to generate perception information, the perception information representing a spray coverage, and processing circuitry configured to cause the system to determine adjusted tuning parameters based on the perception information using a machine learning process, the adjusted tuning parameters being different from current tuning parameters corresponding to the perception information, and control a sprayer based on the adjusted tuning parameters.

### FIELD OF THE DISCLOSURE

Some example embodiments provide systems, methods, and non-transitory computer-readable media for performing closed loop sprayer control to improve sprayer coverage and reduce spraying delay.

### BACKGROUND

The application of different materials to plants includes the delivery of pesticides, fungicides, insecticides, herbicides, as well as various nutrients including fertilizers and organic preparations. In agricultural environments, sprayers are used to perform such material application. Sprayers convert a material application, often containing a mixture of water or other liquid chemical carriers such as fertilizer and any other chemicals, into droplets, which are rain-type drops or tiny, almost invisible mist-like particles.

### SUMMARY

Some example embodiments provide improved systems, methods, and non-transitory computer-readable media that enable improved sprayer coverage and reduced spraying delay.

Some example embodiments provide a system including one or more perception devices configured to generate perception information, the perception information representing a spray coverage, and processing circuitry configured to cause the system to determine adjusted tuning parameters based on the perception information using a machine learning process, the adjusted tuning parameters being different from current tuning parameters corresponding to the perception information, and control a sprayer based on the adjusted tuning parameters.

Some example embodiments provide a method including determining adjusted tuning parameters based on perception information using a machine learning process, the adjusted tuning parameters being different from current tuning parameters corresponding to the perception information, and the perception information representing a spray coverage, and controlling a sprayer based on the adjusted tuning parameters.

Some example embodiments provide a non-transitory computer-readable medium storing instructions that, when executed by at least one processor, cause the at least one processor to perform a method, the method includes determining adjusted tuning parameters based on perception information using a machine learning process, the adjusted tuning parameters being different from current tuning parameters corresponding to the perception information, and the perception information representing a spray coverage, and controlling a sprayer based on the adjusted tuning parameters.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a sprayer, in accordance with some example embodiments;

FIG. 2 illustrates a sprayer being pulled by a tractor while spraying a crop, according to some example embodiments;

FIG. 3 illustrates a tractor and sprayer, according to some example embodiments;

FIG. 4 illustrates a system for controlling a sprayer, according to some example embodiments;

FIG. 5 illustrates a method for training a machine learning process, according to some example embodiments;

FIGS. 6A-6B illustrate graphical representations of example recurrent neural networks for implementing the machine learning process, according to some example embodiments; and

FIG. 7 illustrates a method for controlling a sprayer, according to some example embodiments.

### DETAILED DESCRIPTION

Sprayers, such as blast sprayers, may be used to apply material to crops such as orchards, vineyards, etc. A sprayer may travel through rows of a crop, and use fan-forced or blown air to deliver a liquid material through spray nozzles into trees and/or greenery of the crop. The sprayer may use numerous tuning parameters to spray the crop according to a desired coverage.

Existing devices and methods for spraying a crop rely on an operator of the sprayer to set the tuning parameters prior to spraying a given field of crop (e.g., an orchard). However, relevant characteristics of a field of crop, for example, crop size and/or shape, etc., are not consistent throughout the field and change over time. Accordingly, the tuning parameters set prior to spraying the field result in inconsistent crop coverage. Also, the existing devices and methods involve stopping the sprayer, and pausing a spraying operation of the field, in order to reconfigure the tuning parameters. These stoppages result in excessive delay in completing the spraying operation. However, example embodiments provide improved devices and methods for controlling a sprayer as discussed further below.

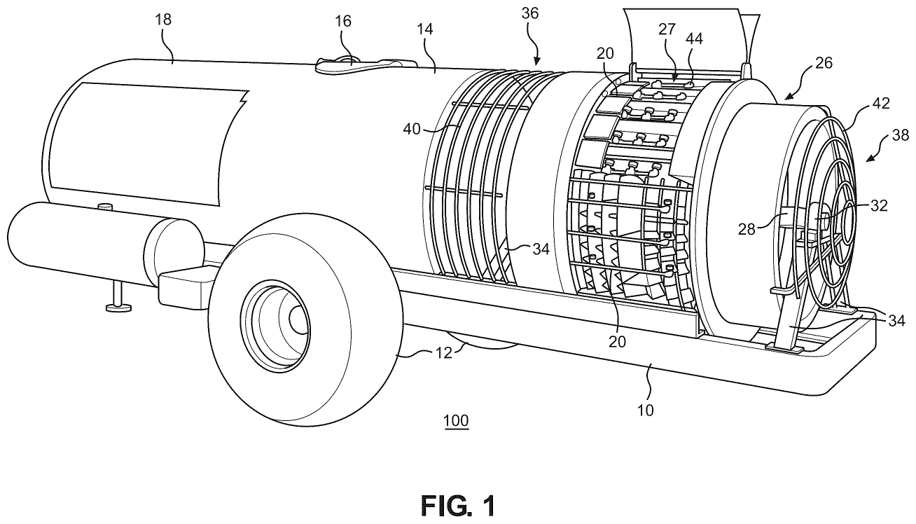

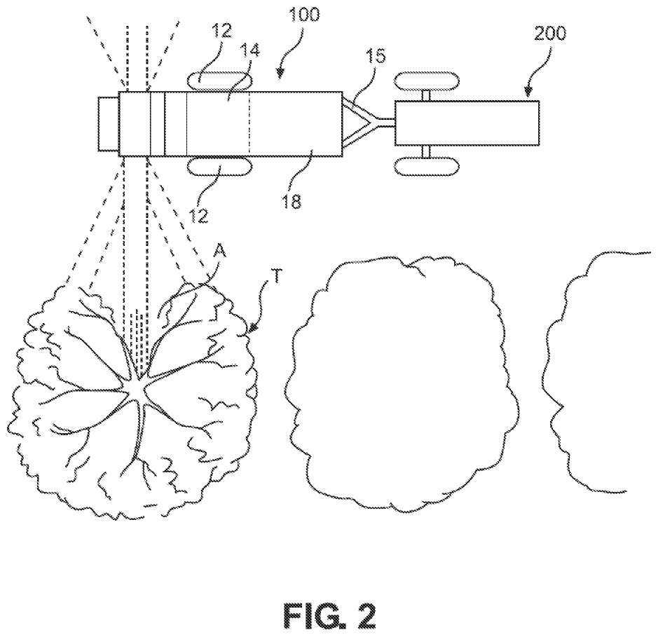

FIG. 1 illustrates a sprayer, in accordance with some example embodiments. FIG. 2 illustrates a sprayer being pulled by a tractor while spraying a crop, in accordance with some example embodiments.

Referring to FIGS. 1 and 2, depicted is a side view of a sprayer 100. The sprayer includes a chassis 10 supported by a pair of wheels 12 and adapted to be drawn through an agricultural field (e.g., an orchard, an orange grove, etc.) by a tractor 200 hitched to a forwardly extending draft bar 15. However, some example embodiments are not limited thereto. According to some example embodiments, the sprayer 100 may be self-propelled. Supported on the chassis 10 centrally of the machine is a tank 14 capable of containing agricultural chemicals (also referred to herein as material) such as plant nutrients, stickers, fungicides, pesticides (including herbicides and/or insecticides), etc. The tank may be filled through an opening closed by a filler cap 16. An engine is mounted within an engine compartment 18 forward of the tank 14 and is adapted to drive a pump through suitable transmission means for pumping the spraying material from the tank 14 to the discharge pipes 20 at the rear of the sprayer 100. The engine is also connected through suitable transmission means including belts to a blower fan mounted within a discharge head, indicated generally at 26, the discharge head having an outlet opening 27. The blower is mounted on a blower shaft 28. The shaft 28 is supported on front and rear bearing blocks 32 (only the rear bearing block being shown) and the bearing blocks are in turn carried by suitable structure 34 on the chassis 10. Mounted to the front and rear of the discharge head 26 are inlet areas 36 and 38 respectively. Disposed over the inlet areas are front and rear safety shields or screens 40 and 42, respectively.

Spray material contained within the tank 14 is caused to be discharged through the nozzles 44 on the discharge pipes 20 by means of the pump which is driven by the engine. As the spray material is being discharged, the fan or blower is simultaneously or contemporaneously driven from the engine, and air drawn in through the inlet areas 36 and 38 is impelled through the outlet opening 27 in the discharge head 26, the spray material discharged through the nozzles 44 being entrained in the discharged air. A blast of air generated by the blower will be distributed radially through the outlet 27 and outwardly of the sprayer 100. The blast of air may be directed toward a portion (e.g., portion A) of a crop (e.g., tree T). According to some example embodiments, the crop may include nut trees, orange groves, grape vines or any other type of agricultural crop for which sprayers (e.g., blast sprayers) may be used to spray the plants in the crop.

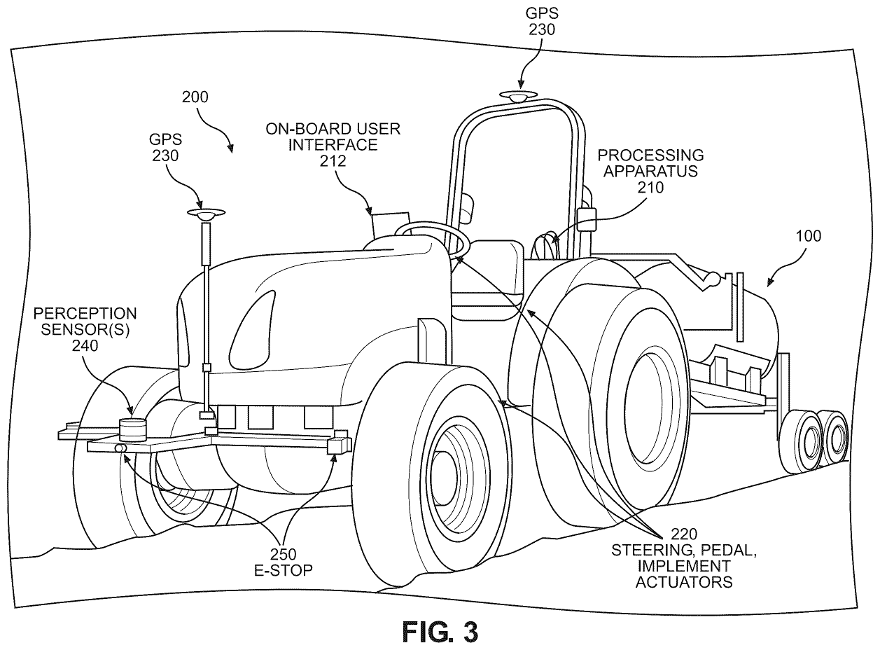

FIG. 3 illustrates a tractor and sprayer, in accordance with some example embodiments.

Referring to FIG. 3 depicted is a view of the tractor 200 pulling the sprayer 100. The tractor 200 may include a processing apparatus 210, an on-board user interface 212 (e.g., including a touchscreen), steering, pedal and implement actuators 220 configured to control the tractor and the sprayer via a manual control interface of the tractor, a global positioning system (GPS) 230, including a reference GPS receiver mounted near the back of the tractor and/or an attitude GPS mounted near the front of the tractor, one or more perception sensors 240 (e.g., including a LiDAR sensor and/or an RGB camera), and e-stops 250 configured to shut down the tractor when they are pressed or activated. However, some example embodiments are not limited thereto. According to some example embodiments, the above-mentioned components on the tractor 200 may be included on the sprayer 100, for example, in implementations which the sprayer 100 is self-propelled. According to some example embodiments, the sprayer 100 may be mechanically controlled, but some example embodiments are not limited thereto. According to some example embodiments, the sprayer 100 may be electronically controlled (e.g., using the steering, pedal and implement actuators 220). According to some example embodiments, the sprayer 100 is a blast sprayer. According to some example embodiments, the sprayer 100 and/or tractor 200 may be autonomous (e.g., fully autonomous or partially autonomous), but some example embodiments are not limited thereto and the sprayer 100 and/or tractor 200 may be controlled (e.g., at least partially controlled) by an operator.

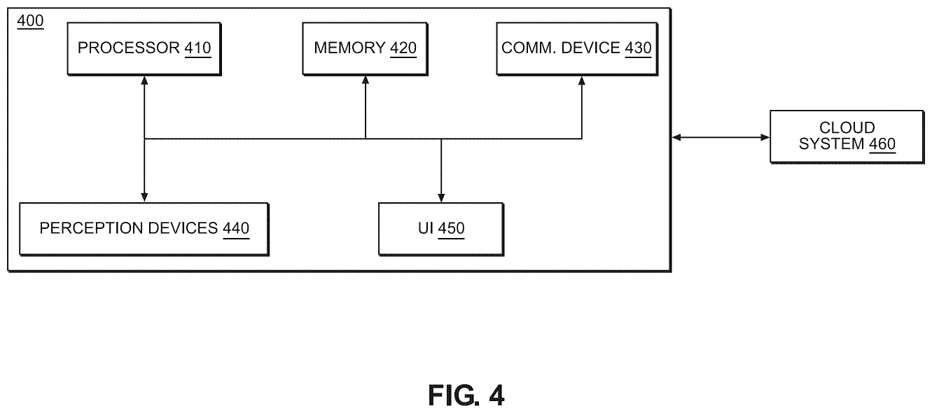

FIG. 4 illustrates a system for controlling a sprayer, according to some example embodiments.

Referring to FIG. 4, a system 400 may include a processor 410, a memory 420, a communication device 430, one or more perception devices 440 (referred to hereinafter as “perception devices” 400) and/or a user interface (UI) 450 (collectively referred to herein as the components of the system 400). According to some example embodiments, the system 400 may be included on the tractor 200 but some example embodiments are not limited thereto and the system 400 may be included on the sprayer 100 (e.g., in implementations in which the sprayer 100 is self-propelled). Also, according to some example embodiments, one or more of the components of the system 400 may be included on the sprayer 100, one or more of the components of the system 400 may be included on the tractor, and/or one or more of the components of the system 400 may be external to both the tractor 200 and the sprayer 100 (e.g., on a cloud system 460, an external server, etc.). According to some example embodiments, the system 400 may include more or fewer components than those discussed above. For example, the system 400 may not include the UI 450 (e.g., in implementations in which the sprayer 100 and/or tractor 200 is autonomous).

The processor 410 (e.g., the processing apparatus 210) may control overall operation of the system 400 and may be implemented using processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The processor 410 may store and/or retrieve data to and/or from the memory 420 (e.g., programming instructions for execution by the processor 410, operational data generated by the processor 410, etc.). The processor 410 may communicate with, and/or control, the communication device 430, the perception devices 440 and/or the UI 450.

The memory 420 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The memory 420 may store data and/or instructions for retrieval by, for example, the processor 410.

The communication device 430 may include a transmitter, a receiver and/or a transceiver. The communication device 430 may communicate with one or more external devices (e.g., the cloud system 460, an external server, a base station, an access point, etc.) via any wired and/or wireless communication method that would be known to a person having ordinary skill in the art. The communication device 430 may communicate signals and/or messages between the processor 410 and the one or more external devices as discussed further below.

The perception devices 440 (e.g., the one or more perception sensors 240) may include one or more cameras and/or one or more LiDAR devices but some example embodiments are not limited thereto. For example, the perception devices 440 may also include a radar device and/or any sensor capable of detecting characteristics of individual plants (e.g., a plant shape, a plant size, a leaf density, a canopy coverage, etc.), spray coverage, etc., that would be known to a person having ordinary skill in the art. The perception devices 440 may detect such characteristics of individual plants in a field of crop. For example, the one or more LiDAR devices (or radar devices) may be mounted on a front of the tractor 200 and/or sprayer 100, may be forward-looking with respect to front of the tractor 200 and/or sprayer 100, and may be used to detect plant shape, plant size, leaf density, canopy coverage, etc. of the individual plants in the field of crop. The one or more LiDAR devices may then provide the characteristics of the individual plants to the processor 410. The processor 410 may use the characteristics for processing operations and/or store the characteristics in the memory 420.

According to some example embodiments, the one or more LiDAR devices may perform scanning using a laser to generate a point cloud. For example, the laser may be emitted in multiple directions (e.g., in directions forward of the front of the tractor 200 and/or sprayer 100) and reflect off of objects, and the one or more LiDAR devices may determine ranges to the objects based on an amount of time measured for the reflected laser to reach the one or more LiDAR devices. The point cloud may include a plurality of points, each of which may be represented by three-dimensional coordinates (e.g., x, y and z coordinates) or two-dimensional coordinates (e.g., x and y coordinates), hereafter generally referred to as coordinates, but some example embodiments are not limited thereto. According to some example embodiments, each of the plurality of points may have additional attributes including scan angle, point density, color value (e.g., red, green and blue values), time stamp, etc. The point cloud may be generated by determining respective coordinates for each among the plurality of points based on the amount of time measured with respect to each of the plurality of points. According to some example embodiments, the coordinates may be determined as global coordinates based on a current geospatial position of the tractor 200 and/or sprayer 100 (e.g., obtained from the GPS 230), however some example embodiments are not limited thereto, and the coordinates may be determined as relative coordinates with respect to the tractor 200 and/or sprayer 100 (e.g., by setting the position of the tractor 200 and/or sprayer 100 as coordinate 0, 0, 0).

According to some example embodiments, the perception devices 440 may detect the characteristics of individual plants (e.g., a plant shape, a plant size, a leaf density, a canopy coverage, etc.), spray coverage, etc. based on the point cloud, but some example embodiments are not limited thereto and the processor 410 may detect the characteristics of the individual plants based on the point cloud. According to some example embodiments, the perception devices 440 (or the processor 410) may classify objects in the point cloud by comparing the point cloud to stored information representative of a plant, leaves, a canopy, a spray, etc. For example, the memory 420 may store a plurality of object templates, each object template corresponding to a plant, leaves, a canopy, a spray, etc., and the perception device 440 (or the processor 410) may compare the plurality of object templates with the point cloud to identify groups of points among the plurality of points corresponding to one or more object templates (e.g., based on the coordinates and/or additional attributes of the plurality of points). The perception device 440 (or the processor 410) may recognize individual plants, leaves, canopies, sprays, etc. within the point cloud based on the groups of points identified as corresponding to object templates for plants, leaves, canopies, sprays, etc., respectively. The perception device 440 (or the processor 410) may measure the characteristics of individual plants (e.g., a plant shape, a plant size, a leaf density, a canopy coverage, etc.), spray coverage, etc., by measuring the groups of points identified as corresponding to the individual plants, leaves, canopies, sprays, etc.

Also, the perception devices 440 may detect a coverage of a material sprayed by the sprayer 100. For example, the one or more cameras may capture images of the material (e.g., a blast spray containing the material) while the sprayer 100 sprays the crop, and provide the captured images to the processor 410. The processor 410 may use the captured images for processing operations and/or store the captured images in the memory 420. According to some example embodiments, the one or more cameras may be mounted on (e.g., mounted on the top of) the sprayer 100 and/or the tractor 200, but some example embodiments are not limited thereto. According to some example embodiments, each of the one or more cameras may be a color camera that captures the images using the visible light spectrum (e.g., red/green/blue (RGB) cameras), however some example embodiments are not limited thereto and each of the one or more cameras may capture the images using any spectrum/spectra of light (e.g., infrared, etc.). According to some example embodiments, each of the one or more cameras may be a stereo camera, but some example embodiments are not limited thereto. According to some example embodiments, the one or more cameras may include one or more lights that emit light in a spectrum/spectra that the one or more cameras is configured to capture. For example, each of the one or more cameras may correspond to a different light among the one or more lights, but some example embodiments are not limited thereto. According to some example embodiments, at least one among the one or more cameras (and/or lights) may be positioned on, and/or directed from, either side of the sprayer 100 (and/or tractor 200) to capture images of the crop being sprayed (e.g., on one or both sides of the sprayer 100) as the sprayer 100 travels through the field (e.g., between rows of the crop in the field), however some example embodiments are not limited thereto.

According to some example embodiments, the perception devices may also include one or more weather sensors, but some example embodiments are not limited thereto. According to some example embodiments, the one or more weather sensors may be mounted on the sprayer 100 and/or the tractor 200, but some example embodiments are not limited thereto. The one or more weather sensors may measure one or more environmental parameters including wind speed, wind direction, humidity (e.g., relative humidity) and/or temperature, but some example embodiments are not limited thereto and the one or more weather sensors may measure additional environmental parameters.

The UI 450 (e.g., the on-board user interface 212) may include one or more devices for communicating information to, and/or receiving information from, an operator of the sprayer 100. For example, the UI 450 may receive tuning parameters (e.g., initial tuning parameters) from the operator to configure the sprayer 100, but some example embodiments are not limited thereto. According to some example embodiments, the tuning parameters (e.g., the initial tuning parameters) may be received from an external device (e.g., the cloud system 460) via the communication device 430, or provided by the processor 410. Also, the UI 450 may receive commands from the operator to initiate and/or terminate a spraying operation, control steering, pedal, and implement actuators 220, etc. According to some example embodiments, the system 400 may not include the UI 450. For example, the operations discussed herein may be performed without interaction from the operator.

According to some example embodiments, a spraying operation of the sprayer 100 may be initiated by an operator of the sprayer 100 (e.g., via the UI 450) but some example embodiments are not limited thereto. According to some example embodiments, the spraying operation may be initiated through remote activation of the sprayer 100 (e.g., via the cloud system 460, a base station, etc.), by the processor 410 based on one or more predefined (or defined or otherwise alternatively, given) conditions, etc. According to some example embodiments, the spraying operation may be performed under the control of the processor 410, but some example embodiments are not limited thereto and the spraying operation may be controlled remotely (e.g., by the cloud system 460, an external server, etc.). Hereinafter, the spraying operation will mainly be described as being performed by the processor 410 for conciseness of explanation.

The processor 410 may obtain an initial set of tuning parameters. For example, the processor 410 may obtain the initial set of tuning parameters from the memory 420 or from an external device (e.g., the cloud system 460) via the communication device 430. According to some example embodiments, the tuning parameters of the sprayer (including the initial set of tuning parameters) may include one or more among a spray speed (e.g., a speed at which the sprayer 100 travels through the field), a fan speed (a speed of the fan/blower 24 of the sprayer 100 which may reflect a range in distance that the spray travels), a spray volume (e.g., a volume (or pressure) of liquid pumped to the discharge pipes 20 and nozzles 44), a spray direction (e.g., a direction in which a nozzle 44 is pointed by an electrical or hydraulic actuator) and/or a sprayer selection, however some example embodiments are not limited thereto and additional tuning parameters may be used. The sprayer selection may include an indication of which sprayer(s), for example, which nozzles 44, will be activated (e.g., configured/enabled to emit spray). Sprayer selection may include activation of sprayers on one of the sides, or both of the sides, of the sprayer 100, and/or may include activation of individual sprayers. According to some example embodiments, the spray direction may be controlled using actuation doors on the sprayer 100 that are electronically controlled by the processor 410.

The processor 410 may perform the spraying operation by spraying the crop in the field with the liquid stored in the tank 14 according to the initial tuning parameters. For example, the processor 410 may control the pedal actuators 220 according to a configured spray speed, control the fan/blower 24 according to a configured fan speed, control the pump of the sprayer 100 according to a configured spray volume, control a hydraulic (or electronic) actuator of one or more of the nozzles 44 according to a configured spray direction and/or control a hydraulic (or electronic) actuator of one or more of the nozzles 44 according to a configured sprayer selection, as indicated in the initial tuning parameters. While the sprayer 100 is spraying the crop (or contemporaneous thereto), the sprayer 100 may travel (e.g., by being pulled by the tractor 200 or under self-propulsion) along the field (e.g., between rows of the field, along only a single row of the field, etc.), but some example embodiments are not limited thereto. According to some example embodiments, the sprayer 100 may sequentially (1) spray the crop, (2) travel to a new position on the field while not spraying, and (3) then spray the crop at the new position.

Repeatedly or continuously during the spraying operation, the processor 410 may determine adjusted tuning parameters based on perception information obtained from the perception devices 440, and apply the adjusted tuning parameters. The perception information may include one or more among (1) the characteristics of individual plants (e.g., the shape, size, leaf density, canopy coverage, etc.) obtained from the one or more LiDAR devices, (2) the captured images obtained from the one or more cameras, and/or (3) the measured one or more environmental parameters obtained from the one or more weather sensors. According to some example embodiments, the perception information may represent (or include information representing) a spray coverage of the spraying operation. According to some example embodiments, the processor 410 may determine the adjusted tuning parameters based on the perception information using a machine learning process.

According to a first example approach, the processor 410 may determine the adjusted tuning parameters by inputting the perception information into a machine learning process (or applying the machine learning process to the perception information). Based on the perception information, the machine learning process may output adjusted tuning parameters (or relative adjustments to current tuning parameters).

According to a second example approach, the processor 410 may input the perception information into the machine learning process (or apply the machine learning process to the perception information) and, based on the perception information, the machine learning process may output a spray quality (e.g., an indication of the spray quality, also referred to herein as a spray quality indication). The processor 410 may use the spray quality indication (e.g., an amount by which a spray blast has overshot or undershot the plants being sprayed) to determine the adjusted tuning parameters (or relative adjustments to current tuning parameters). According to some example embodiments, the spray quality indication may include an amount by which the spray has overshot or undershot the plants (e.g., the canopy) being sprayed. Additionally or alternatively, the spray quality indication may include a difference between (1) a droplet size and/or a cloud density of the spray blast and (2) an intended droplet size and/or an intended cloud density, respectively. According to some example embodiments, the processor 410 may determine the adjusted tuning parameters based on the spray quality indication by reference to a table, or applying a function, stored in the memory 420.

According to some example embodiments, the spray quality indication may include (or may include a representation of) a first distance (e.g., pixel distance) between an outer edge of the spray blast and an outer edge of the plant leaves (e.g., canopy). The first distance may be with respect to the vertical direction, but some example embodiments are not limited thereto. According to some example embodiments, the spray quality indication may include (or may include representations of) distances in both the vertical and horizontal directions (e.g., a first distance and a second distance), or may include (or may include a representation of) a two-dimensional (or three-dimensional) profile representing a continuous outer boundary by which the spray has overshot or undershot the plants. According to some example embodiments, the first distance may be measured between an uppermost edge of the plant leaves and an uppermost edge of the spray blast (e.g., in the case of an overshoot), or between a lowermost edge of the plant leaves and a lowermost edge of the spray blast (e.g., in the case of an undershoot). According to some example embodiments, the second distance may be measured between a forwardmost (in the direction of travel of the sprayer 100 and/or tractor 200) edge of the plant leaves and a rearwardmost (opposite to the direction of travel of the sprayer 100 and/or the tractor 200) edge of the spray blast (e.g., in the case of an overshoot with respect to lateral distance), or between a rearwardmost edge of the plant leaves and a forwardmost edge of the spray blast (e.g., in the case of an undershoot with respect to lateral distance). Although the spray quality indication may include the first distance, the second distance and/or a two-dimensional profile, the spray quality indication will be discussed mainly with respect to the first distance herein for conciseness of explanation.

According to some example embodiments, the processor 410 may convert the first distance (e.g., pixel distance) into an absolute distance (e.g., a geospatial distance, such as feet, meters, etc.) based on a distance from the sprayer 100 to the plants and/or an angle from the sprayer 100 to the leaves of the plants. For example, the processor 410 may perform this conversion based on data from the one or more LiDAR devices, but some example embodiments are not limited thereto. According to some example embodiments, the processor 410 may perform this conversion based on a comparison between a current geospatial location (e.g., obtained from the GPS 230) and a map of the field containing representations of the plants. According to some example embodiments, the processor 410 may also use a current spray angle of the sprayer 100 in performing this conversion.

According to some example embodiments, the spray quality indication may include (or may include a representation of) a first difference between the droplet size of the spray blast and the intended droplet size. The first difference may be a difference with respect to a two-dimensional area, but some example embodiments are not limited thereto. According to some example embodiments, the first difference may be a difference with respect to a three-dimensional volume. For example, the processor 410 may determine a cross-sectional area of one or more droplets of the spray blast based on the perception information (e.g., one or more images from the one or more cameras). According to some example embodiments, the cross-sectional area may be perpendicular to a view direction of the one or more camera, but some example embodiments are not limited thereto. According to some example embodiments, the processor 410 may determine an average (or median) cross-sectional area among a plurality of droplets of the spray blast and determine the first difference as the difference between this average (or median) cross-sectional area and the intended droplet size.

According to some example embodiments, the spray quality indication may include (or may include a representation of) a second difference between the cloud density of the spray blast and the intended cloud density. Both the cloud density of the spray blast and the intended cloud density may refer to the density of the spray blast in the region of the plants/canopy. For example, the processor 410 may determine a cloud density in at least one subregion of the spray blast based on the perception information (e.g., at least a portion of the point cloud generated by the one or more LiDAR devices). According to some example embodiments, the at least one subregion may be located in an area in which the spray blast contacts the leaves/canopy of the plants, but some example embodiments are not limited thereto. According to some example embodiments, the processor 410 may determine an average (or median) cloud density among a plurality of subregions of the spray blast and determine the second difference as the difference between this average (or median) cloud density and the intended cloud density.

According to some example embodiments, the processor 410 may obtain the intended droplet size and/or the intended cloud density from the memory 420 or from an external device (e.g., the cloud system 460) via the communication device 430. The intended droplet size and/or the intended cloud density may correspond to a spray configuration that is predetermined (or determined or alternatively, given) for the crop in the field. According to some example embodiments, the spray quality indication may include an indication of whether the first distance represents an overshoot or undershoot with respect to height, whether the first difference represents a droplet size smaller or larger than the intended droplet size, whether the second difference represents a cloud density greater or less than the intended cloud density, and/or whether the second distance represents an overshoot or undershoot with respect to lateral distance, but some example embodiments are not limited thereto. According to some example embodiments, the first distance may be a positive or negative value respectively representing an overshoot or undershoot with respect to height, the first difference may be a positive or negative value respectively representing a droplet size smaller or larger than the intended droplet size, the second difference may be a positive or negative value respectively representing a cloud density greater or less than the intended cloud density, and/or the second distance may be a positive or negative value respectively representing an overshoot or undershoot with respect to lateral distance.

According to a third example approach, the processor 410 may determine the spray quality indication based on the perception information, and input the spray quality indication into the machine learning process (or applying the machine learning process to the perception information). Based on the spray quality indication, the machine learning process may output the adjusted tuning parameters (or relative adjustments to current tuning parameters). The characteristics of the spray quality indication determined by the processor 410 according to this third example approach may be the same as or similar to those of the spray quality indication determined by the machine learning process according to the second example approach.

According to some example embodiments, the spray quality (e.g., the amount by which the spray has overshot or undershot the plants/canopy) may be determined (e.g., by the processor 410 and/or the machine learning process) based on the captured images from the one or more cameras and/or the characteristics of the individual plants from the one or more LiDAR devices. For example, the processor 410 may detect a spray blast emitted from the sprayer 100 and leaves of the plants in the field (e.g., the canopy) based on the captured images, but some example embodiments are not limited thereto and the processor 410 may detect the leaves of the plants based on the characteristics obtained from the one or more LiDAR devices. According to some example embodiments, the processor 410 may detect the spray blast and/or the plant leaves within the captured images based on the colors of pixels and/or contrasts between colors of adjacent pixels (e.g., green pixels may correspond to the plant leaves, white or gray pixels may correspond to the spray blast, etc.), but some example embodiments are not limited thereto. According to some example embodiments, the processor 410 may process the captured images using an image segmentation algorithm to detect pixels corresponding the plant leaves, blast spray and droplets of the blast spray respectively segmented from the remaining pixels of the captured images. According to some example embodiments, the processor 410 may detect the plant leaves and the blast spray based on a time-varying series of the captured images. For example, the processor 410 may detect leaf movement between images in the series as representing (or corresponding to) leaves being contacted by the blast spray.

The processor 410 may apply the adjusted tuning parameters (e.g., reconfigure the sprayer 100 according to the adjusted tuning parameters) while continuing the spraying operation (without stopping or pausing the spraying operation). According to some example embodiments, based on a detected undershoot of the crop with respect to height, the adjusted tuning parameters may correspond to an increased fan speed (e.g., the amount of increase may correspond to the amount of the undershoot), an adjustment upward of the direction of the activated nozzles 44 (e.g., the amount of adjustment may correspond to the amount of the undershoot), a shift in activation of nozzles 44 from those directed more horizontally to those directed more vertically (e.g., the amount of shift may correspond to the amount of the undershoot), etc. In such cases, the processor 410 may apply the adjusted tuning parameters by increasing the speed of the fan, adjusting the direction of the activated nozzles 44 upward, shifting the activation of the nozzles 44 from those directed more horizontally to those directed more vertically, etc.

According to some example embodiments, based on a detected overshoot of the crop with respect to height, the adjusted tuning parameters may correspond to an decreased fan speed (e.g., the amount of decrease may correspond to the amount of the overshoot), an adjustment downward of the direction of the activated nozzles 44 (e.g., the amount of adjustment may correspond to the amount of the overshoot), a shift in activation of nozzles 44 from those directed more vertically to those directed more horizontally (e.g., the amount of shift may correspond to the amount of the overshoot), etc. In such cases, the processor 410 may apply the adjusted tuning parameters by decreasing the speed of the fan, adjusting the direction of the activated nozzles 44 downward, shifting the activation of the nozzles 44 from those directed more vertically to those directed more horizontally, etc.

According to some example embodiments, based on a detected overshoot of the crop with respect to lateral distance, the adjusted tuning parameters may correspond to a decreased spray speed (e.g., the amount of decrease may correspond to the amount of the overshoot), an adjustment rearward of the direction of the activated nozzles 44 (e.g., the amount of adjustment may correspond to the amount of the overshoot), a shift in activation of nozzles 44 from those directed more forward to those directed more rearward (e.g., the amount of shift may correspond to the amount of the overshoot), etc. In such cases, the processor 410 may apply the adjusted tuning parameters by increasing the speed of the sprayer 100 and/or tractor 200, adjusting the direction of the activated nozzles 44 rearward, shifting the activation of the nozzles 44 from those directed more forward to those directed more rearward, etc.

According to some example embodiments, based on a detected undershoot of the crop with respect to lateral distance, the adjusted tuning parameters may correspond to an increased spray speed (e.g., the amount of increase may correspond to the amount of the undershoot), an adjustment forward of the direction of the activated nozzles 44 (e.g., the amount of adjustment may correspond to the amount of the undershoot), a shift in activation of nozzles 44 from those directed more rearward to those directed more forward (e.g., the amount of shift may correspond to the amount of the undershoot), etc. In such cases, the processor 410 may apply the adjusted tuning parameters by increasing the speed of the sprayer 100 and/or tractor 200, adjusting the direction of the activated nozzles 44 forward, shifting the activation of the nozzles 44 from those directed more rearward to those directed more forward, etc.

According to some example embodiments, based on a determination that the droplet size of the spray blast is smaller than the intended droplet size, the adjusted tuning parameters may correspond to an decreased fan speed (e.g., the amount of decrease may correspond to the amount of the first difference), a decrease in the spray volume (e.g., the amount of decrease may correspond to the amount of the first difference), etc. In such cases, the processor 410 may apply the adjusted tuning parameters by decreasing the speed of the fan 24, decreasing the spray volume by controlling the pump of the sprayer 100 to decrease the volume (or pressure) of spray to the discharge pipes 20 and nozzles 44, etc.

According to some example embodiments, based on a determination that the droplet size of the spray blast is larger than the intended droplet size, the adjusted tuning parameters may correspond to an increased fan speed (e.g., the amount of increase may correspond to the amount of the first difference), an increase in the spray volume (e.g., the amount of increase may correspond to the amount of the first difference), etc. In such cases, the processor 410 may apply the adjusted tuning parameters by increasing the speed of the fan 24, increasing the spray volume by controlling the pump of the sprayer 100 to decrease the volume (or pressure) of spray to the discharge pipes 20 and nozzles 44, etc.

According to some example embodiments, based on a determination that the cloud density of the spray blast is lower than the intended cloud density, the adjusted tuning parameters may correspond to an decreased spray speed (e.g., the amount of decrease may correspond to the amount of the second difference), an increase in the spray volume (e.g., the amount of increase may correspond to the amount of the second difference), etc. In such cases, the processor 410 may apply the adjusted tuning parameters by decreasing the speed of the sprayer 100 and/or tractor 200, increasing the spray volume by controlling the pump of the sprayer 100 to increase the volume (or pressure) of spray to the discharge pipes 20 and nozzles 44, etc.

According to some example embodiments, based on a determination that the cloud density of the spray blast is higher than the intended cloud density, the adjusted tuning parameters may correspond to an increased spray speed (e.g., the amount of increase may correspond to the amount of the second difference), a decrease in the spray volume (e.g., the amount of decrease may correspond to the amount of the second difference), etc. In such cases, the processor 410 may apply the adjusted tuning parameters by increasing the speed of the sprayer 100 and/or tractor 200, decreasing the spray volume by controlling the pump of the sprayer 100 to decrease the volume (or pressure) of spray to the discharge pipes 20 and nozzles 44, etc.

According to some example embodiments, the processor 410 may apply the adjusted tuning parameters by controlling the pedal actuators 220 according to a configured spray speed, control the fan/blower 24 according to a configured fan speed, control the pump of the sprayer 100 according to a configured spray volume, control a hydraulic (or electronic) actuator of one or more nozzles 44 according to a configured sprayer direction and/or control a hydraulic (or electronic) actuator of one or more nozzles 44 according to a configured sprayer selection, as indicated in the adjusted tuning parameters.

The processor 410 may then repeat the determination of the spray quality and/or adjusted tuning parameters, and the application of the adjusted tuning parameters (e.g., throughout the performance of the spraying operation of the field without stopping or pausing the spraying operation). Accordingly, the processor 410 may perform a closed-loop control process of the sprayer 100 during the spraying operation, according to some example embodiments.

According to some example embodiments, improved devices and methods are provided for spraying a crop. For example, as described herein, tuning parameters of the sprayer 100 may be adjusted during the spraying operation based on perception information captured during the spraying operation. This closed-loop control process enables dynamic configuration of tuning parameters (and corresponding spray coverage) without pausing the spraying operation. Accordingly, the improved devices and methods overcome the deficiencies of the existing devices and methods to at least reduce delay in completing the spraying operation. Also, the improved devices and methods provide for improved spray coverage, thereby reducing excess consumption of the material (e.g., pesticide, herbicide, etc.) contained in the spray.

According to some example embodiments, the machine learning process may be trained (or re-trained) based on the current tuning parameters and the perception information (referred to with respect to the training/re-training as current perception information). The current tuning parameters may be the tuning parameters applied at the sprayer 100 at the time that the current perception information was obtained and/or that resulted in a spray blast depicted in the captured images contained in the current perception information.

According to some example embodiments, the spray quality indication may be determined by the machine learning process and/or the processor 410 as discussed further above, but some example embodiments are not limited thereto. According to some example embodiments, the spray quality indication may be determined by an external device (e.g., the cloud system 460, an external server, etc.) using the same processes as or similar processes to those discussed in connection with the second or third example approaches discussed above. The spray quality may reflect an amount of error in the spraying operation. According to some example embodiments, the processor 410 may adjust parameters of the machine learning process to maximize or improve the spray quality (e.g., minimize or reduce the amount by which the spray has overshot or undershot the plants being sprayed).

According to some example embodiments, the processor 410 may adjust the parameters of the machine learning process to minimize or reduce the error represented by the first distance (e.g., maximize or improve the spray quality). According to some example embodiments, the adjustment of the marching learning process parameters is determined (e.g., by the processor 410) relative to the current tuning parameters. For example, the adjustment of the parameters of the machine learning process functions to train (or re-train) the machine learning process such that the machine learning process is configured to output adjusted tuning parameters (relative to the current tuning parameters) that would minimize or reduce the error represented by the first distance. According to some example embodiments, after this training, the machine learning process is configured to output the adjusted tuning parameters in response to re-input of the current perception information into the machine learning process. By periodically or continuously repeating this parameter adjustment (e.g., training/re-training) process during spraying operations of the sprayer 100, the machine learning process becomes increasingly more capable of outputting adjusted tuning parameters (or relative adjustments to current tuning parameters) that minimize or reduce spray overshoot and/or undershoot (e.g., maximize or improve spray quality).

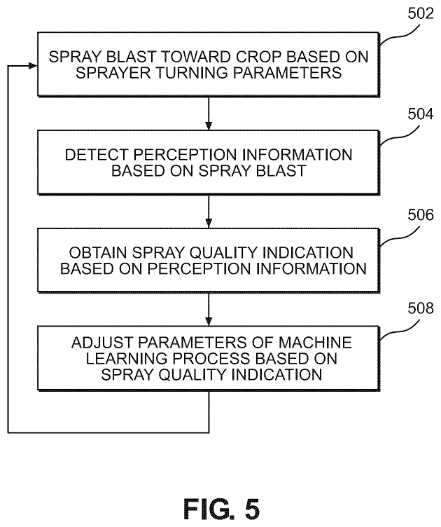

FIG. 5 illustrates a method for training a machine learning process, according to some example embodiments. According to some example embodiments, the method may be performed by the processor 410, but some example embodiments are not limited thereto. According to some example embodiments, the method may be performed by an external device (e.g., the cloud system 460, and external server, etc.), and/or by a combination of the processor 410 and the external device. The method will be mainly described as being performed by the processor 410 to improve conciseness.

Referring to FIG. 5, in operation 502, the sprayer 100 may be configured with first tuning parameters and may spray a first spray blast toward a crop, under control of the processor 410, during a spraying operation of a field. According to some example embodiments, the first tuning parameters may represent adjustments, determined by the machine learning process, to second tuning parameters associated with a second spray blast sprayed before the first spray blast. In operation 504, the processor 410 may detect first perception information based on the first spray blast. In operation 506, the processor 410 may obtain a first spray quality indication (e.g., the first distance, the second distance, the first difference and/or the second difference) based on the first perception information using the second or third example approach described above. In operation 508, the processor 410 may adjust the parameters (and/or weights) of the machine learning process to minimize or reduce the error represented by the first spray quality indication (e.g., to maximize or improve the spray quality). According to some example embodiments, the processor 410 may determine correct tuning parameters based on the first spray quality indication and/or first tuning parameters. For example, the correct tuning parameters may represent tuning parameters using which the first spray blast would not have resulted in an (or would have resulted in a smaller) overshoot or undershoot (e.g., with respect to height and/or lateral distance) (e.g., zero or smaller error). According to some example embodiments, the correct tuning parameters may represent tuning parameters using which the first spray blast would have resulted in a first distance, second distance, first difference and/or second difference of zero or of a minimum (or lower) value. According to some example embodiments, the processor 410 may determine the correct tuning parameters based on the spray quality indication and/or first tuning parameters by reference to at least one table (e.g., one or more look-up tables), or applying at least one function, stored in the memory 420. According to some example embodiments, the processor 410 may determine the correct tuning parameters by making larger adjustments to some tuning parameters among the first tuning parameters and smaller adjustments to other tuning parameters among the first tuning parameters. According to some example embodiments, the processor 410 may determine the correct tuning parameters by adjusting a first subset of the first tuning parameters during a first iteration of the method discussed in connection with FIG. 5, and by adjusting a second subset of the first tuning parameters (different from the first subset of the first tuning parameters) during a second iteration of the method discussed in connection with FIG. 5 (the second iteration being subsequent to the first iteration of the method discussed in connection with FIG. 5).

The processor 410 may then adjust the parameters (and/or weights) of the machine learning process based on the differences between the correct tuning parameters and the first tuning parameters. According to some example embodiments, the processor 410 may apply a loss function to the correct tuning parameters and the first tuning parameters, and determine the adjusted parameters (and/or weights) of the machine learning process using backpropagation, but some example embodiments are not limited thereto.

According to some example embodiments, after completion of operation 508, the method may return to operation 502 and repeat. According to some example embodiments, the method may be repeated periodically or continuously (e.g., throughout the performance of the spraying operation). According to some example embodiments, the method may be performed each time the sprayer 100 is configured with different or adjusted tuning parameters, but some example embodiments are not limited thereto. According to some example embodiments, the method may be performed after the sprayer 100 is configured with different or adjusted tuning parameters a threshold number of times (e.g., 5 times, 10 times, etc.).

Referring back to FIG. 4, in some example embodiments, processing circuitry (e.g., the processor 410) may perform some operations (e.g., the operations described herein as being performed by the machine learning process) by artificial intelligence and/or machine learning. According to some example embodiments, the machine learning process may be (or may include) a machine learning model, a machine learning function, etc. As an example, the processing circuitry may implement an artificial neural network (e.g., as the machine learning process) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning process may have any structure that is trainable, e.g., with training data. For example, the machine learning process may include an artificial neural network, a decision tree, a support vector machine, a Bayesian network, a genetic algorithm, and/or the like. The machine learning process may be described by mainly referring to an artificial neural network, but some example embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

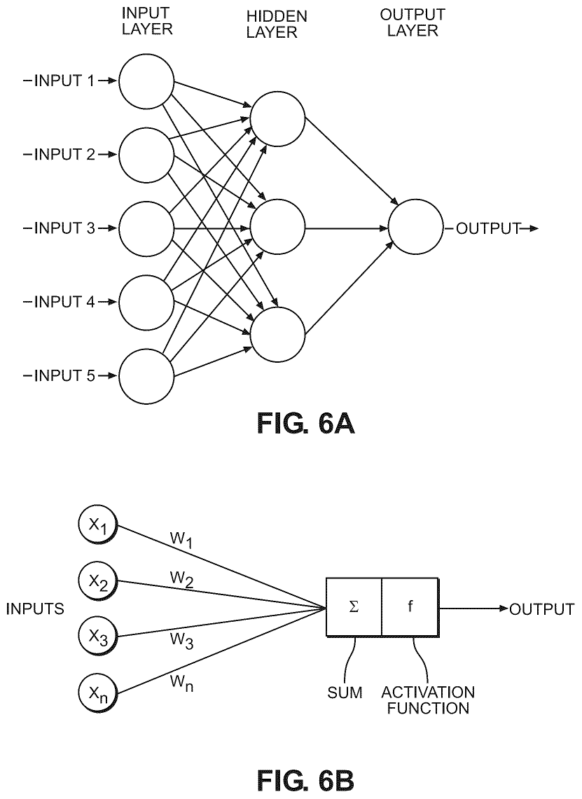

FIGS. 6A-6B illustrate graphical representations of example recurrent neural networks for implementing the machine learning process, according to some example embodiments.

Referring to FIG. 6A, machine learning is a method used to devise complex models and algorithms that lend themselves to prediction (for example, adjusted tuning parameters). Models generated using machine learning, such as those described above, may produce reliable, repeatable decisions and results, and uncover hidden insights through learning from historical relationships and trends in within data.

The use of a recurrent neural-network-based model, and training of the model using machine learning as described above, may enable direct predictions of dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 6A shows a fully connected neural network, where each neuron in a given layer is connected to each neuron in a next layer, according to some example embodiments. In the input layer, each input node is associated with a numerical value, which may be any real number. In each layer, each connection that departs from an input node has a weight associated with it, which may also be any real number (see FIG. 6B). In the input layer, the number of neurons equals number of features (columns) in a dataset. The output layer may have multiple continuous outputs.

The layers between the input and output layers are hidden layers. The number of hidden layers may be one or more (one hidden layer may be sufficient for most applications). A neural network with no hidden layers may represent linear separable functions or decisions. A neural network with one hidden layer may perform continuous mapping from one finite space to another. A neural network with two hidden layers may approximate any smooth mapping to any accuracy.

The number of neurons may be optimized. At the beginning of training, a network configuration is more likely to have excess nodes. Some of the nodes may be removed from the network during training that would not noticeably affect network performance. For example, nodes with weights approaching zero after training may be removed (this process is called pruning). The number of neurons may cause under-fitting (inability to adequately capture signals in dataset) or over-fitting (insufficient information to train all neurons; network performs well on training dataset but not on test dataset).

Various methods and criteria may be used to measure performance of a neural network model. For example, root mean squared error (RMSE) measures the average distance between observed values and model predictions. Coefficient of Determination (R²) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit).

Referring back to FIG. 4, according to some example embodiments, prior to being used during the spraying operation described above, the machine learning process may be initially trained using a set of training data, but some example embodiments are not limited thereto and the machine learning process may be initialized using default values (e.g., default values of parameters of the machine learning process). The training data set may include initial perception information captured during a configuration process in which the sprayer 100 travels through the field (e.g., through rows of the field) along the same path as (or a similar path to) that the sprayer 100 will travel during the spraying operation. For example, the training data set may include captured images from the one or more cameras, characteristics of individual plants from the one or more LiDAR devices, and/or one or more environmental parameters from the one or more weather sensors. According to some example embodiments, the processor 410 may determine the initial parameters of the machine learning process (e.g., initially train the machine learning process) based on the training data set by reference to a table, or applying a function, stored in the memory 420.

According to some example embodiments, the processor 410 may apply different tuning parameters to the sprayer 100 in different geospatial positions of the field. For example, the memory 420 may store the different tuning parameters in association with corresponding geospatial positions. The different geospatial positions may correspond to different positions on the field along a path that will be traveled by the sprayer 100 during the spraying operation. According to some example embodiments, as the sprayer 100 travels along this path during the spraying operation, the processor 410 applies different tuning parameters to the sprayer 100 according to the geospatial position of the sprayer 100 using the associations stored in the memory 420. According to some example embodiments, the processor 410 performs the above-described adjustments of the tuning parameters based on the information obtained from the machine learning process according to the geospatial position corresponding to the current tuning parameters. For example, the processor 410 may update the tuning parameters stored in the memory 420 in association with the geospatial position at which the perception information, on which the output from the machine learning process was based, was captured.

According to some example embodiments, one or more of the operations described above as being performed by the processor 410 may instead (or additionally) be performed by the cloud system 460 and/or an external server in communication with the processor 410 via the communication device 430. According to some example embodiments, in addition to (or alternatively to) the machine learning process being based on computer-readable instructions stored in the memory 420, the computer-readable instructions of the machine learning process may be stored (and/or executed) on an external device (e.g., the cloud system 460, an external server, etc.). In such instances, processor 410 may transmit the perception information and/or spray quality to the external device, and receive the spray quality and/or adjusted tuning parameters from the external device.

According to some example embodiments, the processor 410 may transmit the perception information, the spray quality, the current tuning parameters, the adjusted tuning parameters and/or the (trained or re-trained) machine learning process to the cloud system 460. According to some example embodiments, the cloud system 460 may include computing resources (e.g., a plurality of servers, processors, memory devices, etc.) and may maintain one or more external machine learning processes using the computing resources. For example, the cloud system may maintain an external machine learning process for providing tuning parameters particular to a specific field, to a specific geographical region, to a specific region type (e.g., arid, high-elevation, etc.), to a specific crop type, etc. Additionally or alternatively, the cloud system may maintain an external machine learning process for providing tuning parameters for general use. Each of the one or more external machine learning processes may perform operations similar to those performed by the machine learning process according to any among the first example approach, the second example approach or the third example approach.

According to some example embodiments, the cloud system 460 may further train (e.g., re-train) at least one among the one or more external machine learning processes based on the perception information, the spray quality, the current tuning parameters, the adjusted tuning parameters and/or the (trained or re-trained) machine learning process obtained from the processor 410. For example, the cloud system 460 may train/re-train the at least one external machine learning process based on the spray quality and current tuning parameters using the same process as or a similar process to that described above with respect to the machine learning process. According to some example embodiments, the cloud system 460 may use the received perception information to update (e.g., re-train) an external machine learning process particular to the specific field that the sprayer 100 sprays in the spraying operation to account for plant growth, pruning, weather damage, etc. According to some example embodiments, the cloud system 460 may update (e.g., re-train) an external machine learning process corresponding to the same (or a similar) geographical region, region type, crop type, etc., as/to that represented by the spraying operation of the field.

According to some example embodiments, the machine learning model is a copy of one among the one or more external machine learning processes. According to some example embodiments, prior to beginning the spray operation, the processor 410 may receive the machine learning process from the cloud system for use during the spray operation, but some example embodiments are not limited thereto. According to some example embodiments, the processor 410 may transmit the perception information and/or the spray quality to the cloud system and receive spray quality and/or adjusted tuning parameters from the cloud system, the received spray quality and/or adjusted tuning parameters being obtained from at least one among the one or more external machine learning processes.

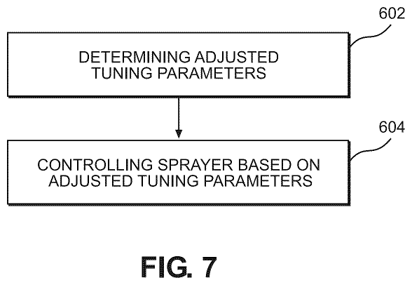

FIG. 7 illustrates a method for controlling a sprayer, according to some example embodiments. According to some example embodiments, the method may be performed by the processor 410, but some example embodiments are not limited thereto. According to some example embodiments, the method may be performed by an external device (e.g., the cloud system 460, and external server, etc.), and/or by a combination of the processor 410 and the external device. The method will be mainly described as being performed by the processor 410 to improve conciseness.

Referring to FIG. 7, in operation 602, the method may include determining adjusted tuning parameters based on perception information using a machine learning process. For example, the processor 410 may obtain perception information from the perception devices, and determine the adjusted tuning parameters according to the first, second or third example approaches discussed above. The perception information may include one or more characteristics of individual plants, the characteristics including a plant shape, a plant size, a leaf density or a canopy coverage. Alternatively or additionally, the perception information may include one or more captured images. Alternatively or additionally, the perception information may include one or more environmental parameters, for example, a wind speed, a wind direction, a humidity or a temperature. The perception information may represent an amount by which a spray has overshot or undershot a plant.

In operation 604, the method may include controlling a sprayer based on the adjusted tuning parameters. For example, the processor 410 may control the sprayer 100 based on the adjusted tuning parameters as discussed above. The adjusted tuning parameters may include parameters for control of a spray speed, a fan speed, a spray volume, a sprayer selection and/or a nozzle direction of the sprayer 100. The controlling may include spraying a plant with a material. According to some example embodiments, the method may also include re-training the machine learning process based on the perception information and the current tuning parameters, the perception information corresponding to control of the sprayer based on the current tuning parameters.

According to some example embodiments, the above-described method may be repeated periodically or continuously throughout a spray operation of a field, but some example embodiments are not limited thereto. According to some example embodiments, the above-described method may be performed, and/or repeated periodically or continuously, without stopping or pausing the spraying operation.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 420).

According to some example embodiments, the memory 420 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. A system, comprising:
one or more perception devices configured to generate perception information, the perception information representing a spray coverage; and
processing circuitry configured to cause the system to
determine adjusted tuning parameters based on the perception information using a machine learning process, the adjusted tuning parameters being different from current tuning parameters corresponding to the perception information, and
control a sprayer based on the adjusted tuning parameters.

2. The system of claim 1, wherein the adjusted tuning parameters include at least one of:
a spray speed;
a fan speed;
a spray volume;
a sprayer selection; or
a nozzle direction.

3. The system of claim 1, wherein the perception information includes at least one of:
one or more characteristics of individual plants, each of the one or more characteristics including a plant shape, a plant size, a leaf density or a canopy coverage; or
one or more captured images.

4. The system of claim 3, wherein the perception information includes one or more environmental parameters, the one or more environmental parameters including a wind speed, a wind direction, a humidity or a temperature.

5. The system of claim 1, wherein the perception information represents an amount by which a spray has overshot or undershot a plant.

6. The system of claim 5, wherein the processing circuitry is configured to cause the system to re-train the machine learning process based on the perception information and the current tuning parameters, the perception information corresponding to a control of the sprayer based on the current tuning parameters.

7. The system of claim 1, wherein the processing circuitry is configured to cause the system to control the sprayer based on the adjusted tuning parameters by spraying a plant with a material.

8. A method, comprising:
determining adjusted tuning parameters based on perception information using a machine learning process, the adjusted tuning parameters being different from current tuning parameters corresponding to the perception information, and the perception information representing a spray coverage; and
controlling a sprayer based on the adjusted tuning parameters.

9. The method of claim 8, wherein the adjusted tuning parameters include at least one of:
a spray speed;
a fan speed;
a spray volume;
a sprayer selection; or
a nozzle direction.

10. The method of claim 8, wherein the perception information includes at least one of:
one or more characteristics of individual plants, the characteristics including a plant shape, a plant size, a leaf density or a canopy coverage; or
one or more captured images.

11. The method of claim 10, wherein the perception information includes one or more environmental parameters, the one or more environmental parameters including a wind speed, a wind direction, a humidity or a temperature.

12. The method of claim 8, wherein the perception information represents an amount by which a spray has overshot or undershot a plant.

13. The method of claim 12, further comprising:
re-training the machine learning process based on the perception information and the current tuning parameters, the perception information corresponding to control of the sprayer based on the current tuning parameters.

14. The method of claim 8, wherein the controlling comprises spraying a plant with a material.

15. A non-transitory computer-readable medium storing instructions that, when executed by at least one processor, cause the at least one processor to perform a method, the method comprising:
determining adjusted tuning parameters based on perception information using a machine learning process, the adjusted tuning parameters being different from current tuning parameters corresponding to the perception information, and the perception information representing a spray coverage; and
controlling a sprayer based on the adjusted tuning parameters.

16. The non-transitory computer-readable medium of claim 15, wherein the adjusted tuning parameters include at least one of:
a spray speed;
a fan speed;
a spray volume;
a sprayer selection; or
a nozzle direction.

17. The non-transitory computer-readable medium of claim 15, wherein the perception information includes at least one of:
one or more characteristics of individual plants, the characteristics including a plant shape, a plant size, a leaf density or a canopy coverage; or
one or more captured images.

18. The non-transitory computer-readable medium of claim 17, wherein the perception information includes one or more environmental parameters, the one or more environmental parameters including a wind speed, a wind direction, a humidity or a temperature.

19. The non-transitory computer-readable medium of claim 15, wherein
the perception information represents an amount by which a spray has overshot or undershot a plant; and
the method further comprises re-training the machine learning process based on the perception information and the current tuning parameters, the perception information corresponding to control of the sprayer based on the current tuning parameters.

20. The non-transitory computer-readable medium of claim 15, wherein the controlling comprises spraying a plant with a material.
